(19) United States
(12) Patent Application Publication
(10) Pub. No.: US 2012/0038125 A1
(43) Pub. Date: Feb. 16, 2012

(54) MONOCOQUE ROLLERSKI

(75) Inventor: Emilio Caverzan, Caerano di San Marco (IT)

(73) Assignee: Nones Sport S.R.L, Catell-Monlina di Fiemme (IT)

(21) Appl. No.: 13/062,606

(22) PCT Filed: Sep. 23, 2009
(86) PCT No.: PCT/EP2009/062218

§ 371 Date: Mar. 7, 2011

(30) Foreign Application Priority Data
Sep. 23, 2008 (IT) TV2008A00021

(51) Int. Cl. B62K 19/02; B29C 70/02

(52) U.S. Cl. 280/63; 156/245

(57) ABSTRACT

A roller ski includes a frame structure that is operatively connected to at least a rear wheel and a front wheel. The frame structure includes at least one beam member that includes an outer shell having a first non-metal material, and an inner core, which includes a second non-metal material.

### CROSS-REFERENCE TO RELATED APPLICATIONS

This application is a national stage application which claims benefit under 35 USC 371 to co-pending International Application PCT/EP2009/062218, filed Sep. 21, 2009, and which claims priority under the Paris Convention to Italian application serial no. TV2008A000121, filed on Sep. 23, 2008, the entire contents of each of which are incorporated herein by reference.

### BACKGROUND

The present disclosure relates to a roller ski having improved performance.

Roller skis are widely known in the state of the art.

A traditional roller ski structure comprises a supporting frame including a beam having ends provided with wheel mounts for operatively connecting to one or more wheels.

Different constructional technologies are currently adopted for providing the supporting frame.

According to a first known solution, the frame comprises a metal bar that is machined at the two ends to allow wheel mounting. Wheel mounts are also made of a metal material.

This solution has the advantage of a reduced weight but it provides poor shock absorption on rough ground and poor reaction to forces imparted by the user during the sports activity.

According to another known solution, the frame includes a beam composed of honeycomb wood panels. At the beam ends two metal blocks are fixed, suitably machined to allow wheel mounting.

This arrangement provides excellent absorption on rough ground and good reaction to forces from the user but it is characterised by high weight and loss of flexibility through use.

According to a further known solution, the frame includes a beam composed of two parallel metal side struts, which act also as wheel mount, said parallel struts being joined by moulded plastic material.

This solution is characterised by average weight, good absorption on rough ground and poor reaction to forces exerted by the user. The practice has shown that losses of flexibility may arise through use.

In general, such a constructional solution is also characterised by a relatively short lifespan of the equipment due to different flexibility of the materials used.

According to a further solution, composite materials are used to bind the two parallel metal side struts forming the frame beam.

This kind of structure is characterised by a low weight but it has many disadvantages, such as poor shock absorption, poor reaction to forces exerted by the user, loss of flexibility through use and reduced lifespan.

According to yet a further solution, the frame includes a beam made of composite fibre materials and metal wheel mounts.

This frame structure provides good absorption on rough ground and good reaction to mechanical stresses. Main disadvantages are a high weight and reduced lifespan of the equipment due to different flexibility of the materials used.

### SUMMARY

The present disclosure overcomes the drawbacks of the state of the art by providing a roller ski structure according to one or more embodiments.

In a further aspect, the present disclosure provides also a process for manufacturing a roller ski structure according to another embodiment.

### BRIEF DESCRIPTION OF THE DRAWINGS

The present disclosure will be now described in details with reference to the attached figures, in which:

FIG. 1 shows a lateral view of a preferred embodiment of the roller ski structure, according to an embodiment; and

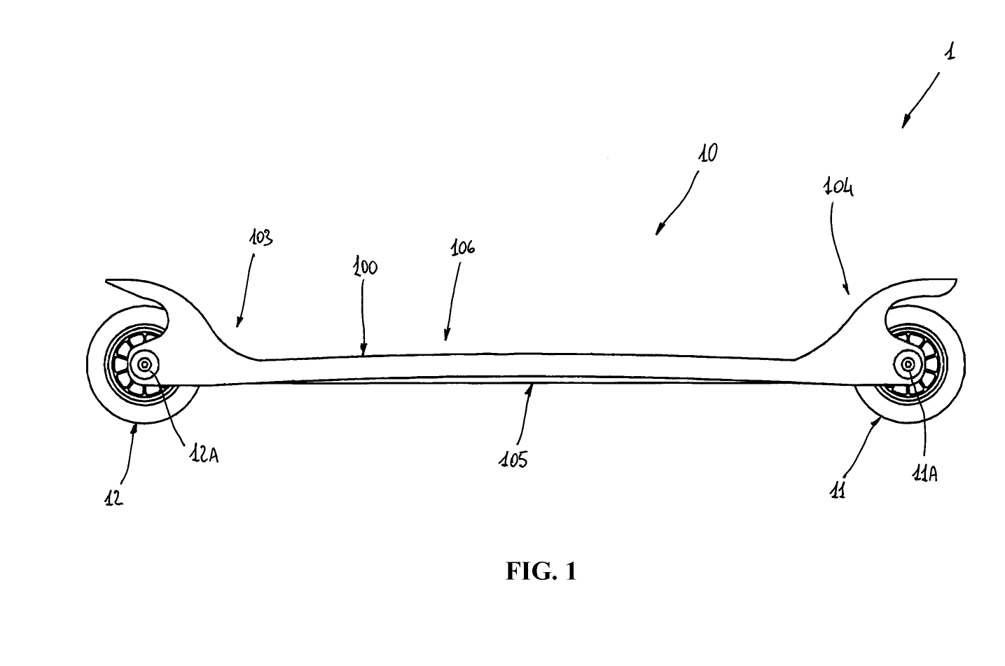

FIG. 2 shows a lower view of the roller ski structure of FIG. 1; and

FIG. 3 shows a lateral view of the supporting frame in the roller ski structure of FIG. 1; and

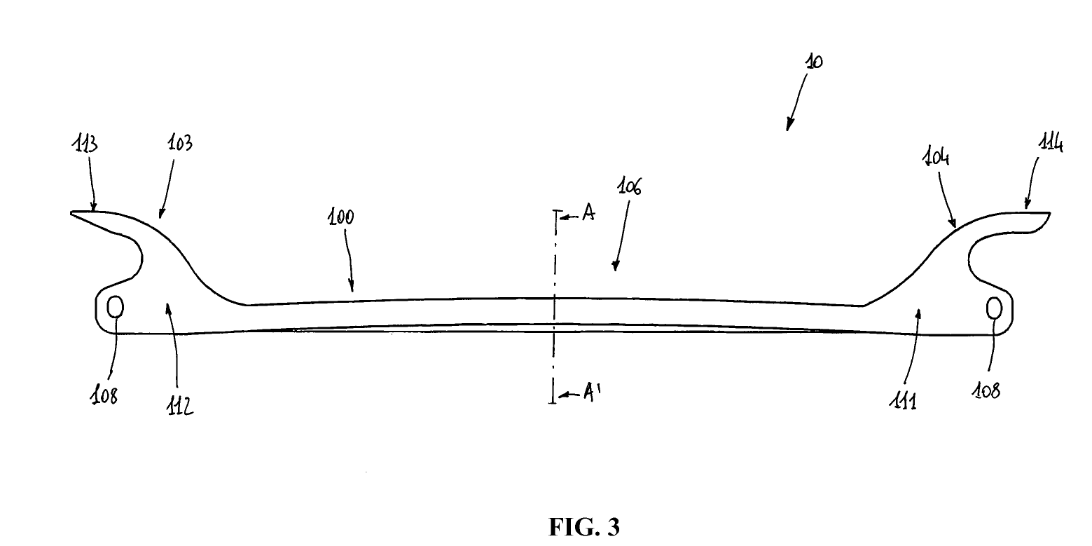

FIG. 4 shows a sectional view A-A′ of the supporting frame of FIG. 3; and

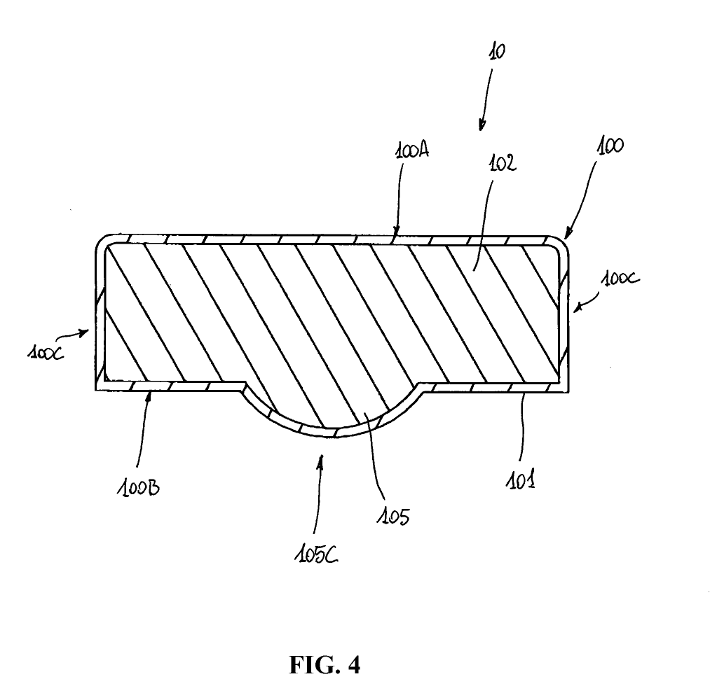

FIG. 5 shows a portion of the supporting frame of FIG. 3; and

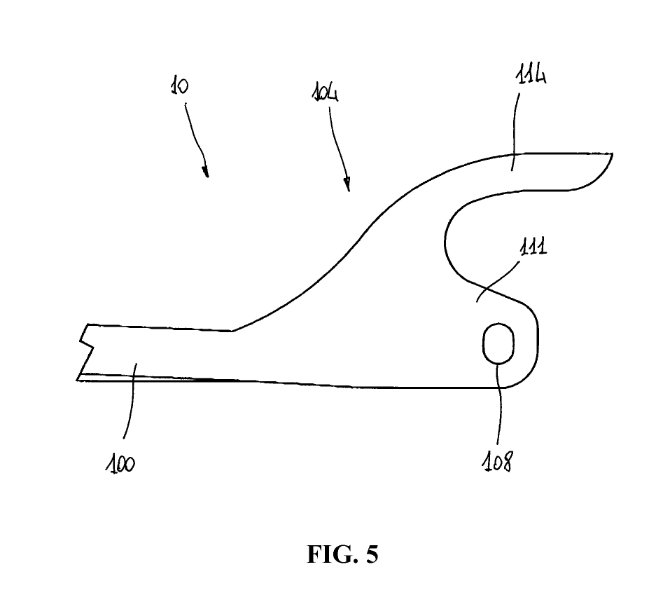

FIG. 6A-6B show the roller ski structure of FIG. 1 in two different operative positions; and

FIG. 7A-7B show perspective views of inserts for mounting wheels used in the roller ski structure of FIG. 1.

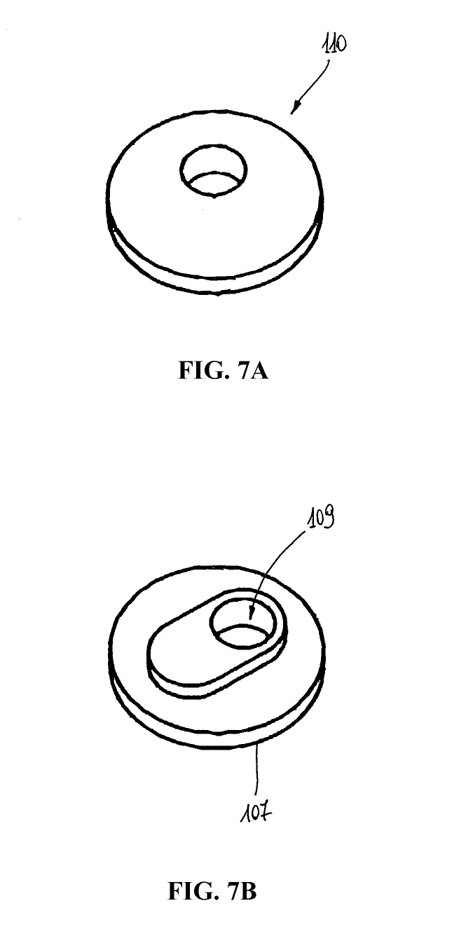

### DETAILED DESCRIPTION

Referring to the cited figures, the present disclosure relates to a roller ski structure 1, which comprises a supporting frame 10 that is operatively connected to at least a rear wheel 11 and a front wheel 12.

The supporting frame 10 has a monocoque structure that comprises at least a beam member, preferably a single beam member 100.

The beam member 100 comprises an outer rigid shell 101, which comprises a first non-metal material, preferably carbon or a composite material, such a carbon fibre composite material or a glass-fibre composite material. Plastic materials may be preferably avoided for the outer shell 101.

The beam member 100 comprises also an inner core 102, which comprises a second non-metal filling material, which can be wood or PVC (Polyvinyl Chloride) or a thermoplastic material or polystyrene.

The beam member 100 comprises a substantially quadrangular cross-section, having the lower and upper faces 100B and 100A and the side faces 100C.

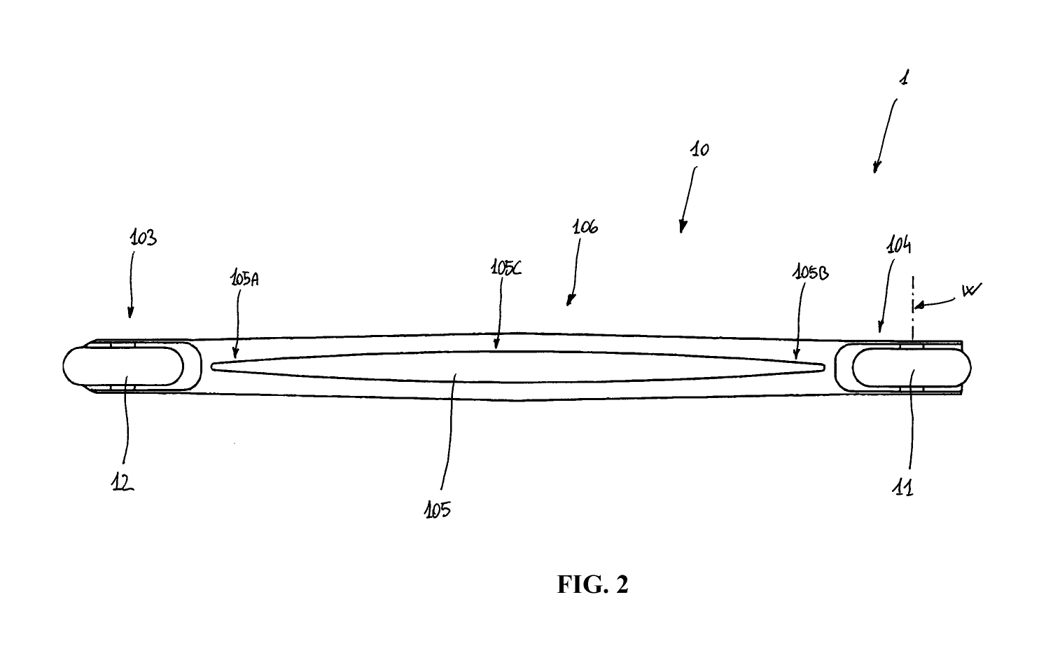

As it is possible to appreciate from FIG. 2, the cross section of the beam member 100 is slightly larger at a central region 106 thereof, so as to provide a larger support for the user's foot.

The side faces 100C of the beam member 100 are thus preferably arranged in parallel and outwardly curved.

Preferably, the beam member 100 comprises a reinforcing rib 105.

Such a reinforcing rib extends along the length of the beam at the lower face 100B, from which it downwardly projects at least partially.

The reinforcing rib 105 has a thickness that preferably varies along the length of the beam member 100, said thickness being lower at the end regions 103 and 104 and higher at the central region 106 of the beam member 100.

Advantageously, at the end regions 103 and 104 the thickness of the reinforcing rib 105 is substantially equal to zero, while at the central region 106 it is about 6 mm.

The reinforced rib 105 is thus preferably shaped as a reversed arch, having a couple of narrower ends 105A and 105B, which drown in the main body of the beam member 100, and a wider curved central portion 105C, protruding down of the lower face 100B of the beam member 100.

The reinforcing beam is thus designed so that the central portion 105C of the reinforcing rib 105 is positioned lower than the centre of mass, the remaining upper portion of the beam member 100 being positioned higher than the centre of mass.

When the beam member is subjected to pressure, the upper portion is elongated while the rib central portion 105C is subjected to traction.

The beam member 100 can thus easily bend for a certain interval (around 4 mm), after which the bending of the beam member 100 is progressively blocked even if pressure increases.

The end regions 103 and 104 of the beam member 100 are advantageously structured, so as to act as wheel mounts and fenders for the wheels 11 and 12 of the roller ski structure.

Preferably, each of the end regions 103 and 104 is shaped as an overturned-U, so as to form the fenders 113 and 114 and the wheel mounts 111 and 112.

Preferably, each of the wheel mounts 111 and 112 comprises a couple of substantially vertical slots 108, each of which housing an end of the pins 11A or 12A of the corresponding wheels 11 or 12.

A perforated metal insert 107 can be arranged in each of the slots 108 and kept in position therein thanks to a further perforated metal insert 110.

Each metal insert 107 has a through hole 109 that is eccentrically placed and that is aimed at accommodating an end of the wheel pins 11A or 12A.

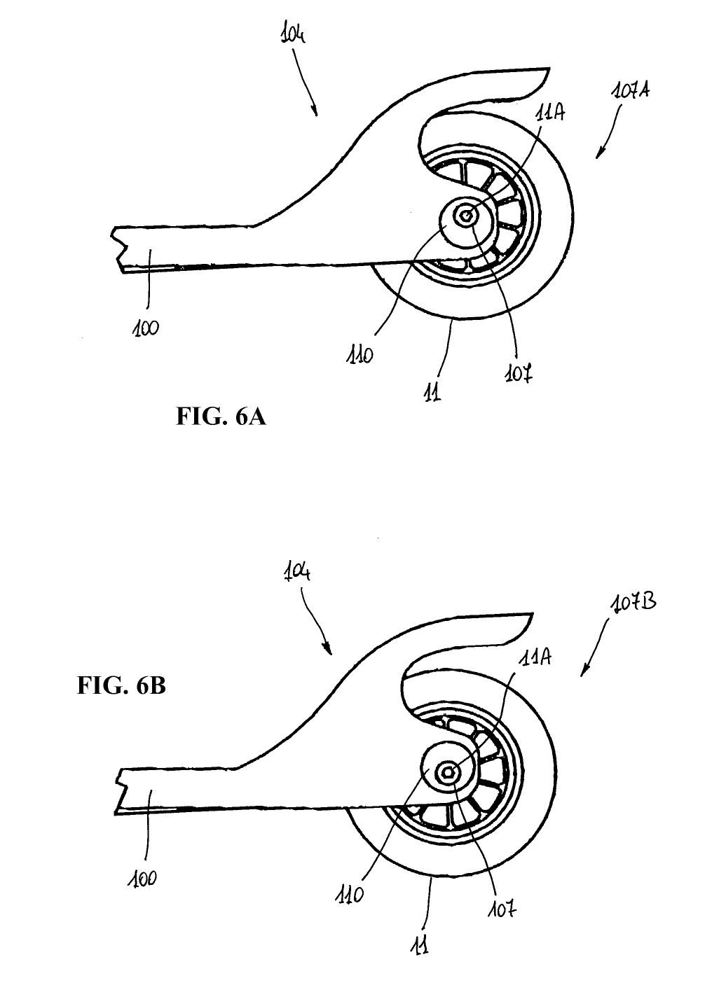

Each metal insert 107 can thus be arranged in the corresponding vertical slot 108, according to a first position 107A (FIG. 6A), corresponding to an upper position for the wheel axis (W), or a second position 107B (FIG. 6B), corresponding to a lower position for the wheel axis (W).

The axes (W) of the wheels 11 and 12 can thus be lowered or raised according to the needs, each of the different operative positions of the metal inserts 107 corresponding to a different position of the centre of mass of the roller ski 1.

The supporting frame 10 is preferably manufactured according to a process which comprises the following steps of:

providing one or more layers of said first non-metal material;

providing a solid frame core element, which comprises said second non-metal material;

coating said solid core with said layers of first material;

placing the assembly so obtained in a mould;

heating the mould so as to cure said layers of first material and forming at least a beam member having an outer rigid shell surrounding said solid core.

In other words, a manufacturing process for the supporting frame 10 preferably consists in creating a substantially quadrangular-shaped tube, including a solid core made of said second non-metal material, on which various layers of said first non-metal material are superimposed. At the two ends of the tube, the carbon-based material canvases have no core and therefore have the form of a single layer. The first material layers are then cured in a mould placed in a press or autoclave.

The monocoque structure so obtained can then be subsequently machined to create the slots 108 for constraining the wheels.

The roller ski, according to the present disclosure, differs from conventional products due to its extreme lightness and elasticity.

It absorbs the ground roughness, offering greater comfort and excellent response to the forces imparted by the user during thrust. As the elasticity of the non-metal materials of the beam member is known, the thrust exerted by the user is in fact returned almost completely while in known roller skis the majority of the thrust is absorbed by the metal parts that are present thereof

1. A roller ski structure, comprising:
a supporting frame that is operatively connected to at least a rear wheel and a front wheel
wherein said supporting frame comprises at least one beam member comprising a rigid outer shell, which comprises a first non-metal material, and an inner core comprising a second non-metal material.

2. A roller ski according to claim 1, wherein said first non-metal material is carbon or a composite material.

3. A roller ski according to claim 1, wherein said first non-metal material is a carbon-fibre composite material or glass-fibre composite material.

4. A roller ski according to claim 1, wherein said second non-metal material comprises a material selected from the group consisting of: wood, PVC, or a thermoplastic material, and polystyrene.

5. A roller ski according to claim 1, wherein said beam member comprises overturned-U shaped ends, each of said ends respectively forming a fender and a wheel mount.

6. A roller ski according to claim 1, wherein said beam member comprises a substantially quadrangular cross-section.

7. A roller ski, according to claim 1, wherein said beam member comprises a reinforcing rib, which extends along a length of said beam member, said reinforcing rib projecting at least partially down of a lower surface of said beam member.

8. A roller ski according to claim 7, wherein a thickness of said reinforcing rib varies along the length of said beam member.

9. A roller ski according to claim 8, wherein a thickness of said reinforcing rib is higher at a central region of said beam member and lower at ends of said beam member.

10. A roller ski, according to claim 1, wherein said beam member comprises at least a wheel mount comprising a substantially vertical slot, in which a perforated metal insert is configured to be arranged according to different positions, each of said positions corresponding to a different position of a center of mass of the roller ski.

11. A method of manufacturing a roller ski supporting frame, the method comprising:
providing one or layers of a first non-metal material;
providing a solid frame core, which comprises a second non-metal material;
coating said solid core with said one or more layers of said first non-material material;
placing the assembly so obtained in a mould; and
heating said mould so as to cure said layers of said first non-metal material and forming at least a beam member having an outer rigid shell surrounding said solid core.

12. The method of claim 11, wherein said first non-metal material is carbon or a composite material.

13. The method of claim 11, wherein said first non-metal material is a carbon-fibre composite material or glass-fibre composite material.

14. The method of claim 11 wherein said second non-metal material is selected from the group consisting of: wood, PVC, a thermoplastic material, and polystyrene.
